(19) United States
(12) Patent Application Publication
(10) Pub. No.: US 2010/0241434 A1
(43) Pub. Date: Sep. 23, 2010

(54) MULTI-CHANNEL DECODING DEVICE, MULTI-CHANNEL DECODING METHOD, PROGRAM, AND SEMICONDUCTOR INTEGRATED CIRCUIT

(76) Inventor: Kojiro Ono, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/513,797

(22) PCT Filed: Feb. 14, 2008
(86) PCT No.: PCT/JP2008/000221

§ 371 Date: May 6, 2009

(30) Foreign Application Priority Data
Feb. 20, 2007 (JP) 2007-038990

(51) Int. Cl. G10L 19/00

(52) U.S. Cl. 704/500; 704/E19.005

(57) ABSTRACT

The multi-channel decoding device (20) according to the present invention is a multi-channel decoding device which converts a monaural frequency signal (106) of an input channel count that is at least one into adjustment frequency signals (109) of an output channel count that is greater than the input channel count. The multi-channel decoding device (20) includes a channel expansion unit (102) which generates expansion frequency signals (107) of the output channel count by expanding the channel count of the monaural frequency signal (106) of the input channel count, and a sound quality adjustment unit (132) which generates the adjustment frequency signals (109) of the output channel count by adding, at a predetermined ratio, one of the expansion frequency signals (107) of the output channel count and the monaural frequency signal (106).

### TECHNICAL FIELD

The present invention relates to multi-channel decoding devices, multi-channel decoding methods, programs, and semiconductor integrated circuits, and particularly to a multi-channel decoding device which converts an input audio signal of an input channel count that is at least one into output audio signals of an output channel count that is greater than the input channel count.

### BACKGROUND ART

In recent years, an encoding technique referred to as MPEG Surround has been standardized in the Moving Picture Coding Experts Group (MPEG) audio standard. MPEG Surround is a technique which decodes a monaural signal or stereo signals into multi-channel signals.

In MPEG Surround, multi-channel signals recorded in multi-channel is encoded into a monaural signal or stereo signals. The encoded monaural signal or stereo signals is transmitted, using a conventional broadcast or distribution, to an audio playback device that includes a multi-channel decoding device. Furthermore, expansion information, which is a parameter computed when the multi-channel signals are encoded into the monaural signal or stereo signals, is also transmitted to the audio playback device at the same time. The multi-channel decoding device included in the audio playback device decodes the received monaural signal or stereo signals into the multi-channel signals using the expansion information (for example, see non-patent document 1).

In the non-patent document 1, the multi-channel decoding device decodes a monaural signal or stereo signals into multi-channel signals, using the parameter computed when 2-channel signals are encoded into a 1-channel signal and the parameter computed when 3-channel signals are encoded into 2-channel signals.

FIG. 1 is a block diagram showing the structure of the multi-channel decoding device disclosed in the non-patent document 1. A multi-channel decoding device 50 shown in FIG. 1 is a MPEG Surround decoder which decodes a monaural signal 100 encoded in conformity with MPEG Surround into multi-channel signals 105, using expansion information 103 computed when encoded.

The monaural signal 100 is a time signal before multi-channel decoding is performed by MPEG Surround. MPEG Surround is designed in such a manner that multi-channel decoding is applied to a monaural signal or stereo signals of a conventional audio codec. For the monaural signal, a signal is used which is decoded in an Advanced Audio Coding (AAC) scheme or AAC+Special Band Replication (SBR) scheme in MPEG standard.

First, a frequency analysis unit 101 generates a monaural frequency signal 106 which is a frequency signal that is monaural by performing time-frequency conversion on the monaural signal 100. Next, a channel expansion unit 102 expands, using the expansion information 103, the channel count of the monaural frequency signal 106 to expansion frequency signals 107 that are six frequency signals. Finally, a frequency synthesis unit 104 generates the multi-channel signals 105 of 6-channels by converting the expansion frequency signals 107 into respective time signals.

FIG. 2 is a generalized diagram of the multi-channel decoding device 50.

The MPEG Surround decoder mainly reproduces a monaural signal or stereo signals into 5.1-channel signals. FIG. 2 shows the generalized view of the channel expansion unit 102. In other words, the MPEG Surround decoder serves to increase the channel count of an audio signal.

FIG. 3 is a diagram showing the flow of the signal in the channel expansion unit 102 when a monaural signal is reproduced into 5.1-channel signals in the MPEG Surround.

The monaural frequency signal 106 is a signal in which six signals: center (c); subwoofer (LEF); left (L); right (R); surround left (Ls); and surround right (Rs), are downmixed.

The channel expansion unit 102 includes five separation units 110 through 114.

First, the separation unit 110 separates the monaural frequency signal 106 into two: a downmixed signal 116 of center and subwoofer; and a downmixed signal 115 of left, right, surround left and surround right. Next, the separation unit 112 separates the downmixed signal 116 into a center channel signal 123 and a subwoofer channel signal 124. On the other hand, the separation unit 111 separates the downmixed signal 115 into a downmixed signal 117 of left and surround left and a downmixed signal 118 of right and surround right. The separation unit 113 separates the downmixed signal 117 into a left channel signal 119 and a left surround channel signal 120, and the separation unit 114 separates the downmixed signal 118 into a right channel signal 121 and a right surround channel signal 122.

As described, by using the MPEG Surround, it is possible to expand a conventional monaural or stereo audio codec to a multi-channel audio codec.

Further, the expansion information 103 used in the MPEG Surround is very small compared to the bit rate of the conventional audio codec. With this, the MPEG Surround can reproduce a realistic sound experience of the multi-channel in a bit rate comparable to the conventional audio codec.

Non-Patent Document 1: 118^{th} AES convention, Barcelona, Spain, 2005, Convention Paper 6447

### DISCLOSURE OF INVENTION

### Problems that Invention is to Solve

As described, the MPEG Surround decoder repeats signal separation to generate the multi-channel signals 105 of 6-channels from the monaural frequency signal 106. By playing back the multi-channel signals 105 of 6-channels, a user can obtain a realistic sound experience which a 1-channel monaural frequency signal 106 cannot provide.

However, the six expansion frequency signals 107 are not included in the monaural frequency signal 106 which is the expansion source as they are, but the respective six expansion frequency signals 107 are obtained through the separation processing. Furthermore, the monaural frequency signal 106 is a signal in which multi-channel signals of 6-channels are encoded. Thus, some parts of the original signals may be lost in encoding and the channel expansion unit 102 may not be able to reproduce the original six signals completely. In other words, sound quality degradation may occur in the respective signals of the multi-channel signals 105. This may cause the user to recognize the sound quality degradation and feel uncomfortable.

More specifically, when continuous sound with subtle changes of pitch is encoded, sound in a certain sound range is lost according to the change of pitch, which causes interruption of the continuous sound. As a result, the user recognizes the interruption obviously, and feels uncomfortable.

In addition, when the separation processing is not performed properly, the sound which should be outputted continuously through a single speaker, may be outputted alternately through several speakers, thereby causing the user to feel uncomfortable.

In the conventional audio codec, when the bit rate is low, the user may also feel uncomfortable with the sound quality. In such a case, increasing the bit rate may solve the problem. However, it is impossible to control the bit rate in broadcasting stream and the like; and thus the user has to stop the playback or put up with the uncomfortable feeling in the playback.

In order to improve such conventional problems, the present invention has an object to provide a multi-channel decoding device which can reduce the user's uncomfortable feeling.

### Means to Solve the Problems

In order to achieve the object, the multi-channel decoding device according to the present invention is a multi-channel decoding device which converts an input audio signal of an input channel count that is at least one into output audio signals of an output channel count that is greater than the input channel count, and the multi-channel decoding device includes: a first expansion unit which generates expansion signals of the output channel count by expanding a channel count of the input audio signal of the input channel count; and a first addition unit which generates one of the output audio signals of the output channel count by adding, at a predetermined ratio, one of the expansion signals of the output channel count and the input audio signal.

With this configuration, the multi-channel decoding device according to the present invention can improve the sound quality of the output audio signals by adding, to the expansion signals, the high quality input audio signal on which the expansion processing has not been performed, when the user feels uncomfortable with the sound quality of the multi-channel signals. As a result, the multi-channel decoding device according to the present invention can reduce the user's uncomfortable feeling.

Furthermore, the multi-channel decoding device may further include: a first conversion unit which generates the input audio signal of the input channel count by converting an input time signal of the input channel count from a time signal to a frequency signal; and a second conversion unit which generates output time signals of the output channel count by converting each of the output audio signals of the output channel count from a frequency signal to a time signal, in which the first expansion unit may generate the expansion signals of the output channel count by expanding the channel count of the input audio signal of the input channel count, each of the expansion signals being a frequency signal, the input audio signal being a frequency signal converted by the first conversion unit, and the first addition unit may generate the output audio signals of the output channel count by adding, at the predetermined ratio, one of the expansion signals of the output channel count and the input audio signal, each of the output audio signals, the expansion signals and the input audio signal being a frequency signal.

With this configuration, the multi-channel decoding device according to the present invention adds, to the expanded frequency signals (expansion signals), the high quality frequency signal (input audio signal) on which the expansion processing has not been performed. As a result, it is possible to realize the sound quality adjustment processing in a simple algorithm.

Furthermore, the first expansion unit may include a first conversion unit which generates an input frequency signal of the input channel count by converting the input audio signal of the input channel count from a time signal to a frequency signal; and a second expansion unit which generates the expansion signals of the output channel count by expanding a channel count of the input frequency signal of the input channel count, and the first addition unit may include: a second conversion unit which generates output time signals of the output channel count by converting each of the expansion signals of the output channel count from a frequency signal to a time signal; and a second addition unit which generates the output audio signals of the output channel count by adding, at the predetermined ratio, one of the output time signals of the output channel count and the input audio signal, each of the output audio signals being a time signal.

With this configuration, the multi-channel decoding device according to the present invention adds, to the expanded time signals (output time signals), the high-quality time signal (input audio signal) on which the expansion processing has not been performed. As a result, the multi-channel decoding device according to the present invention can realize the sound quality adjustment processing without directly changing the parameter of the inside of the decoder.

Furthermore, the first addition unit may weight a certain frequency-time band of the input audio signal, and add, at the predetermined ratio, one of the expansion signals of the output channel count and the input audio signal.

With this configuration, it is possible to perform minimum sound quality adjustment by adjusting the sound quality only of the certain frequency-time band in which human hearing easily perceives the sound degradation. As a result, it is possible to improve the sound quality without losing the realistic sound experience of the multi-channel signals. For example, it is possible to maintain the realistic sound experience of the multi-channel signals by improving the sound quality of the low band which human easily perceives.

Furthermore, the multi-channel decoding device may further include an information input unit which generates gain information that designates the predetermined ratio according to an operation of a user, in which the first addition unit may add one of the expansion signals of the output channel count and the input audio signal at the predetermined ratio designated by the gain information.

With this configuration, the user can select whether the sound quality is to be adjusted or not, and also set the strength or the like of the sound quality adjustment.

Furthermore, the information input unit may accept a plurality of modes each designating the predetermined ratio according to the operation of the user.

With this configuration, by preparing the modes for the general sound quality adjustment in advance, the user can control the sound quality adjustment through simple operation such as selecting the mode without performing the detailed sound quality adjustment.

Furthermore, the information input unit may generate the gain information which designates the predetermined ratio for each of the output audio signals of the output channel count according to the operation of the user, and the first addition unit may add each of the expansion signals of the output channel count and the input audio signal at the corresponding predetermined ratio designated by the gain information.

With this configuration, the user can select whether the sound quality is to be adjusted or not, and also set the strength or the like of the sound quality adjustment with respect to each channel. As a result, the multi-channel decoding device according to the present invention can improve the user's convenience.

Furthermore, the information input unit may include an adjusting knob for designating the predetermined ratio by the user successively changing the predetermined ratio.

With this configuration, the user can easily set the strength or the like of the sound quality adjustment by controlling the adjusting knob. Further, the user can perform the subtle sound quality adjustment by controlling the adjusting knob when the user experiences subtle uncomfortable feeling with the sound quality.

Furthermore, the input audio signal of the input channel count may be generated by synthesizing audio signals of the output channel count, and the first expansion unit may generate the expansion signals of the output channel count by expanding the channel count of the input audio signal of the input channel count, using expansion information which is generated in the synthesizing and indicates an inter-channel relationship of the audio signals.

Furthermore, the input channel count may be two or more, and the first addition unit may average the two or more input audio signals, and add, at the predetermined ratio, one of the expansion signals of the output channel count and the averaged input audio signal.

With this configuration, the multi-channel decoding device which expands the stereo signals into the multi-channel signals, can improve the sound quality of the output audio signals. As a result, the multi-channel decoding device according to the present invention can reduce the user's uncomfortable feeling.

Furthermore, the multi-channel decoding method according to the present invention is a multi-channel decoding method for converting an input audio signal of an input channel count that is at least one into output audio signals of an output channel count that is greater than the input channel count, and the method includes: generating expansion signals of the output channel count by expanding a channel count of the input audio signal of the input channel count; and generating one of the output audio signals of the output channel count by adding, at a predetermined ratio, one of the expansion signals of the output channel count and the input audio signal.

With this, the multi-channel decoding method according to the present invention can improve the sound quality of the output audio signals by adding, to the expansion signals, the high quality input audio signal on which the expansion processing has not been performed. As a result, the multi-channel decoding method according to the present invention can reduce the user's uncomfortable feeling.

It should be noted that the present invention can be implemented, not only as the multi-channel decoding device mentioned above, but also as a multi-channel decoding method which includes the characteristic units of the multi-channel decoding device as steps, or a program that causes a computer to execute those steps. As a matter of course, such a program may be distributed via a recording medium such as CD-ROM, or transmission media such as the Internet.

The present invention can also be implemented as a semiconductor integrated circuit which includes the characteristic units of the multi-channel decoding device, and an audio playback device including the multi-channel decoding device.

### EFFECTS OF THE INVENTION

With the above described configurations, the present invention can provide the multi-channel decoding device which can reduce the users' uncomfortable feeling.

### BRIEF DESCRIPTION OF DRAWINGS

FIG. 1 is a diagram showing a structure of a conventional multi-channel decoding device.

FIG. 2 is a diagram showing a generalized structure of the multi-channel decoding device.

FIG. 3 is a diagram showing a structure of a channel expansion unit.

FIG. 4 is a diagram showing a structure of a vehicle according to a first embodiment of the present invention.

FIG. 5 is a diagram showing a structure of a multi-channel decoding device according to the first embodiment of the present invention.

FIG. 6 is a flowchart showing the flow of the operations of the multi-channel decoding device according to the first embodiment of the present invention.

FIG. 7 is a diagram showing a structure of a sound quality adjustment unit according to the first embodiment of the present invention.

FIG. 8 is a diagram showing a structure of a variation of the multi-channel decoding device according to the first embodiment of the present invention.

FIG. 9 is a diagram showing a structure of a synthesis unit according to the first embodiment of the present invention.

FIG. 10 is a diagram showing an example where gain dynamically changes according to the frequency band in the sound quality adjustment unit according to the first embodiment of the present invention.

FIG. 11 is a diagram showing a structure of a multi-channel decoding device according to a second embodiment of the present invention.

FIG. 12 is a flowchart showing the flow of the operations of the multi-channel decoding device according to the second embodiment of the present invention.

FIG. 13 is a diagram showing a structure of a sound quality adjustment unit according to the second embodiment of the present invention.

FIG. 14 is a diagram showing a surrounding structure of a sound quality adjustment unit in a variation of the multi-channel decoding device according to the second embodiment of the present invention.

### NUMERICAL REFERENCES

10 Vehicle
11 Speaker
20, 21, 30, 50 Multi-channel decoding device
100 Monaural signal
101 Frequency analysis unit
102 Channel expansion unit
103 Expansion information
104 Frequency synthesis unit
105, 105i Multi-channel signal
106, 108 Monaural frequency signal
106A, 106B Stereo frequency signal
107, 107i Expansion frequency signal
109, 109i Adjustment frequency signal
110, 111, 112, 113, 114 Separation unit
115, 116, 117, 118 Downmixed signal
119 Left channel signal
120 Left surround channel signal
121 Right channel signal
122 Right surround channel signal
123 Center channel signal
124 Subwoofer channel signal
130, 170, 171 Delay unit
131 Information input unit
132, 172 Sound quality adjustment unit
141 Sound quality adjustment information
150, 151, 165, 166, 190, 191 Amplification unit
152, 167, 192 Addition unit
160 Stereo signal
161 Synthesis unit
180 Monaural time signal
181, 181i, 182, 182i Expansion time signal
193, 194 Equalizer

### BEST MODE FOR CARRYING OUT THE INVENTION

Hereinafter, embodiments of a multi-channel decoding device according to the present invention will be described in detail with reference to the drawings. An example in which the multi-channel decoding device according to the present application is applied to an audio device for a vehicle will be described below.

### First Embodiment

A multi-channel decoding device according to a first embodiment of the present invention adds, to multi-channel signals, an input audio signal with higher sound quality than respective signals of the multi-channel signals, when a user feels uncomfortable with the sound quality of the multi-channel signals. With this, sound degradation can be solved, which results in reducing the user's uncomfortable feeling.

First, the structure of the multi-channel decoding device according to the first embodiment of the present invention will be described.

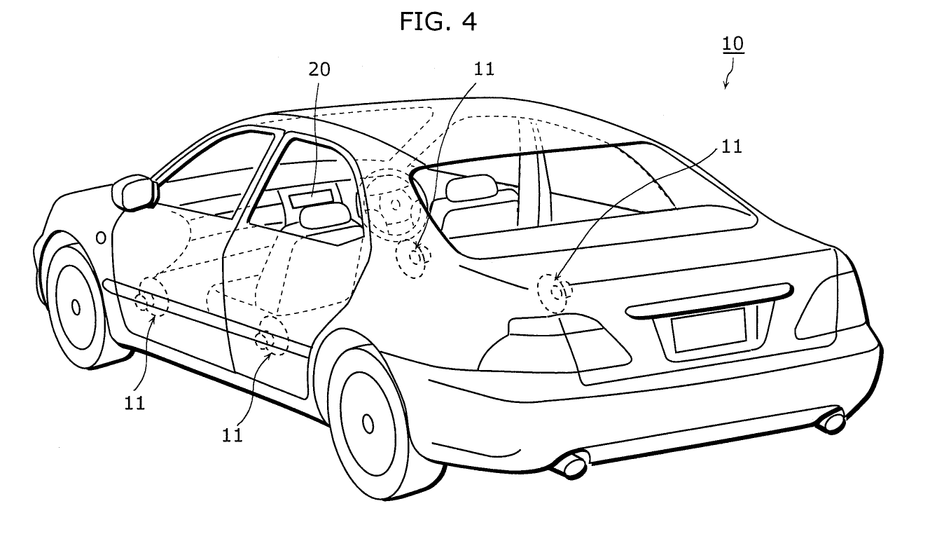

FIG. 4 is a diagram showing the structure of a vehicle including the multi-channel decoding device according to the first embodiment of the present invention.

A vehicle 10 shown in FIG. 4 includes a multi-channel decoding device 20 and several speakers 11. The multi-channel decoding device 20 expands, to multi-channel signals, a monaural signal or stereo signals included in a broadcast audio stream received by an antenna of the vehicle 10, and outputs the multi-channel signals through several speakers 11.

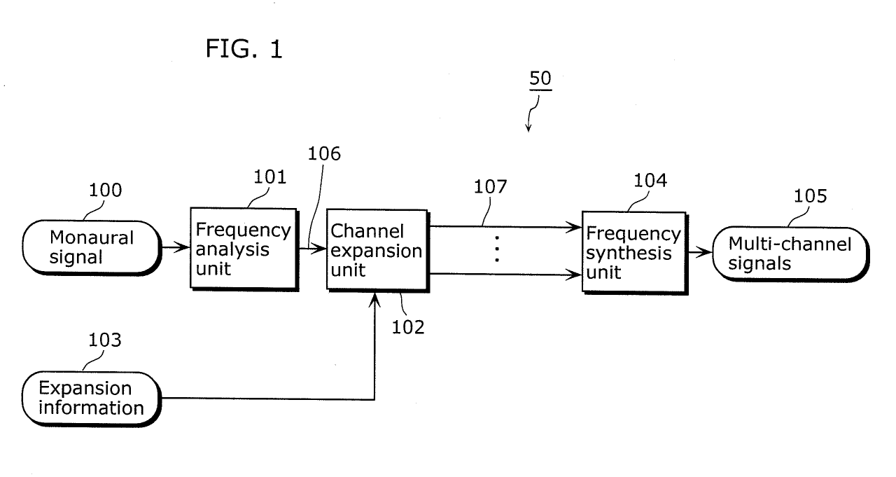

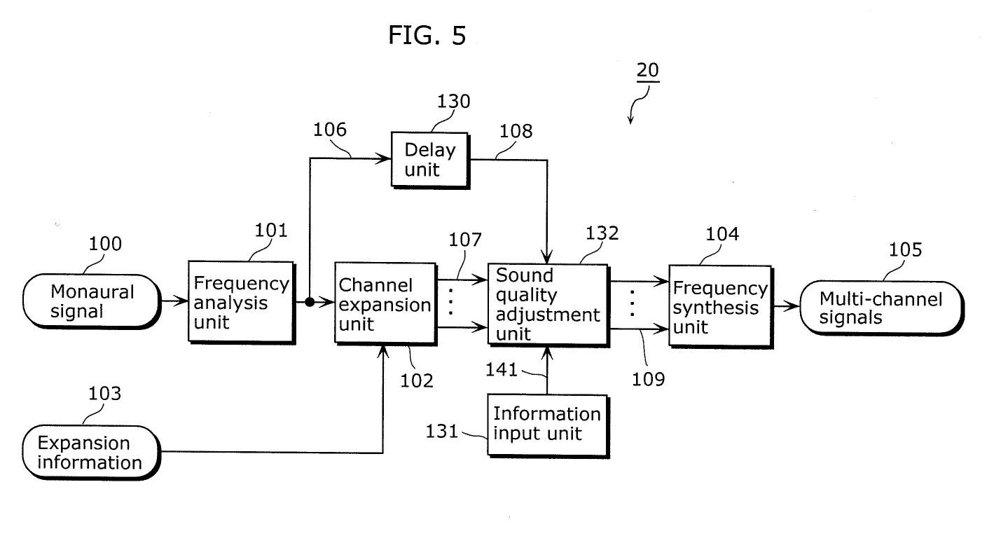

FIG. 5 is a block diagram showing the structure of the multi-channel decoding device according to the first embodiment. It should be noted that identical numerals are assigned to the elements similar to those of FIG. 1.

The multi-channel decoding device 20 shown in FIG. 5 converts a monaural frequency signal 106 that is a 1-channel input audio signal into multi-channel signals 105 that are 5.1-channel output audio signals by performing, using expansion information 103, a channel expansion processing on the monaural frequency signal 106.

The multi-channel decoding device 20 includes a frequency analysis unit 101, a channel expansion unit 102, a delay unit 130, an information input unit 131, a sound quality adjustment unit 132 and a frequency synthesis unit 104.

A monaural signal 100 is a time signal before multi-channel decoding is performed by the MPEG Surround. The monaural signal 100 is a decoding result of a conventional audio codec. The monaural signal 100 is a monaural signal generated by synthesizing multi-channel signals recorded in 5.1-channels.

The frequency analysis unit 101 generates the monaural frequency signal 106 which is a frequency signal that is monaural by converting the monaural signal 100 from a time signal into a frequency signal.

More specifically, in the MPEG Surround, the frequency analysis unit 101 uses a Quadrature Mirror Filters (QMF) filter bank to generate the monaural frequency signal 106 including QMF coefficients. When multi-channel expansion is performed on a frequency axis, the frequency analysis unit 101 may perform frequency conversion according to the multi-channel expansion processing instead of using the QMF filter bank.

The channel expansion unit 102 generates 6-channel expansion frequency signals 107 that are six monaural frequency signals by expanding the channel count of the monaural frequency signal 106, using the expansion information 103. Hereinafter, expanding the channel count may also be referred to as channel expansion.

The expansion information 103 is information which is generated when the multi-channel signals of 5.1-channels are encoded into the monaural signal 100, and which indicates inter-channel relationships of the multi-channel signals. More particularly, the expansion information 103 includes inter-channel level ratio and phase differences.

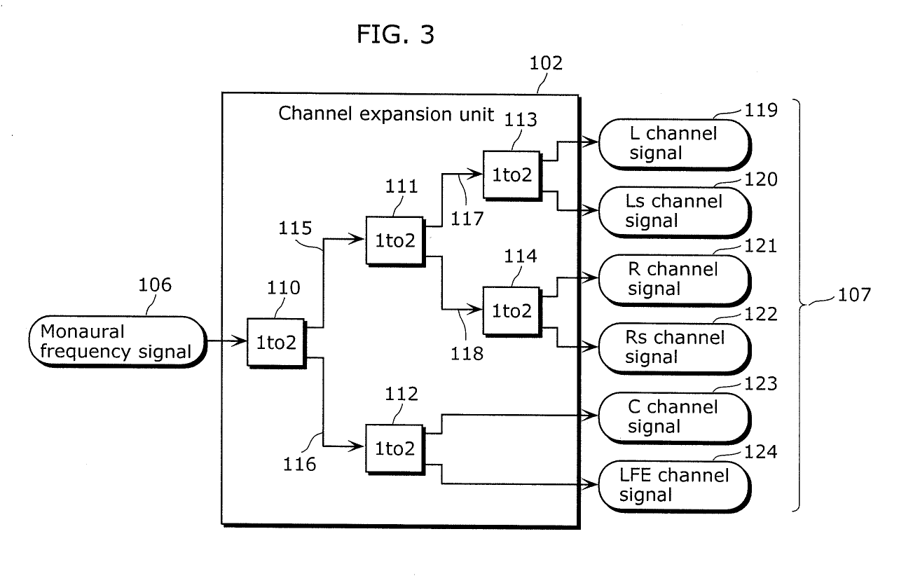

Furthermore, as shown in FIG. 3, the channel expansion unit 102 generates two downmixed signals 115 and 116 from the monaural frequency signal 106, and repeats the operation to eventually generate six expansion frequency signals 107, that are multi-channel signals.

The delay unit 130 generates a monaural frequency signal 108 by giving the monaural frequency signal 106 the delay equivalent to the time period for processing in the channel expansion unit 102. In other words, the delay unit 130 delays the monaural frequency signal 106 so that the time difference between the six expansion frequency signals 107 and the monaural frequency signal 106 can be eliminated.

The information input unit 131 is a terminal for feedback from the user's evaluation to the multi-channel signals 105, and may be a button, adjusting knob, touch panel, remote control and the like. The information input unit 131 generates, according to the user's operation, sound quality adjustment information 141 that is information indicating the instruction for sound quality adjustment. For example, the sound quality adjustment information 141 includes information such as sound quality is not to be changed or sound quality is to be changed.

The sound quality adjustment unit 132 adjusts, based on the sound quality adjustment information 141, the sound quality of the six-channel expansion frequency signals 107, using the monaural frequency signal 108. More particularly, the sound quality adjustment unit 132 generates 6-channel adjustment frequency signals 109 by adding the respective 6-channel expansion frequency signals 107 and the monaural frequency signal 108 at a predetermined ratio.

The frequency synthesis unit 104 generates the multi-channel signals 105 of 6 channels by converting each of the 6-channel adjustment frequency signals 109 from a frequency signal to a time signal.

The functions of the respective processing units shown in FIG. 5 are implemented by a processor such as a CPU executing a program. Among the functions of the respective processing units shown in FIG. 5, some or all parts may be implemented by a dedicated circuit (hardware). For example, among the functions of the respective processing units shown in FIG. 5, the circuit which implements some or all parts may be formed as a semiconductor integrated circuit.

The operations of the multi-channel decoding device 20 configured as above will be described.

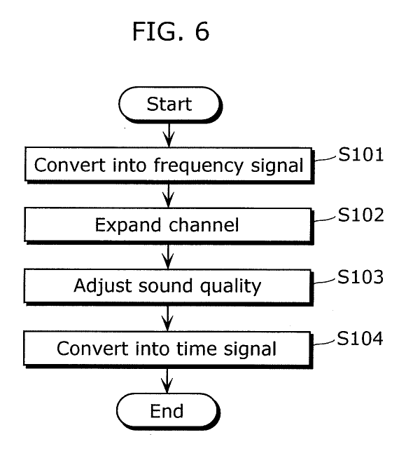

FIG. 6 is a flowchart showing the flow of the operations of the multi-channel decoding device 20.

First, the frequency analysis unit 101 converts the monaural signal 100 into the monaural frequency signal 106 (S101).

Next, the channel expansion unit 102 generates the 6-channel expansion frequency signals 107 by expanding the channel of the monaural frequency signal 106 (S102).

Then, the sound quality adjustment unit 132 adjusts the sound quality of the six expansion frequency signals 107 based on the sound quality adjustment information 141 (S103).

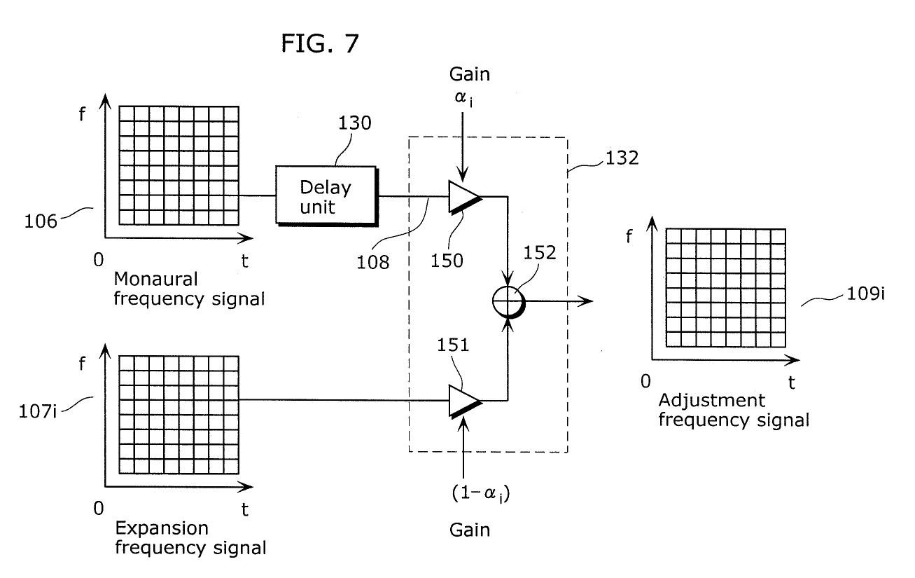

FIG. 7 is a diagram showing the structure of the sound quality adjustment unit 132.

Here, an example will be described where the sound quality adjustment is performed on an expansion frequency signal 107i that is one of the six expansion frequency signals 107 to generate an adjustment frequency signal 109i. The expansion frequency signal 107i is an i-th channel signal among the six expansion frequency signals 107. Furthermore, the adjustment frequency signal 109i is an i-th channel signal among the six adjustment frequency signals 109. Here, since the channel count of the multi-channel signals is assumed as 6, i is assumed to take the value between 0 and 5. For example, when i is 0, the expansion frequency signal 107i is the frequency signal of the left channel generated in the expansion processing.

The sound quality adjustment unit 132 includes amplification units 150 and 151, and an addition unit 152.

FIG. 7 shows the structure for adjusting the sound quality of the single expansion frequency signal 107i only; however, the sound quality adjustment unit 132 actually includes six sets of the amplification units 150 and 151 and the addition units 152 for adjusting the sound quality of the respective six expansion frequency signals 107.

The information input unit 131 receives, according to the user's operation, information which designates gain αi (where i=0 to 5) corresponding to the respective six expansion frequency signals 107. The information input unit 131 generates the sound quality adjustment information 141 including the information which designates the gain αi (where i=0 to 5), and outputs the generated sound quality adjustment information 141 to the sound quality adjustment unit 132.

The amplification unit 150 amplifies the monaural frequency signal 108 using the gain αi designated by the sound quality adjustment information 141. The amplification unit 151 amplifies the expansion frequency signal 107i using the gain (1-αi). The addition unit 152 generates the adjustment frequency signal 109i by adding the signals amplified by the amplification units 150 and 151.

Next, the frequency synthesis unit 104 generates the multi-channel signals 105 of 6-channels by converting the respective 6-channel adjustment frequency signals 109 into time signals (S104).

Hereinafter, an example of the user's operation to the multi-channel decoding device 20 will be described.

The information input unit 131 includes an input unit for feedback from the user's sound quality evaluation. For example, when the user wishes to maintain the current sound quality, the user inputs, to the information input unit 131, information indicating that the sound quality is not to be changed. Based on the information inputted by the user that the sound quality is not to be changed, the information input unit 131 outputs the sound quality adjustment information 141 including information which indicates that the gain αi (where i=0 to 5) is 0.0.

Due to this, the gain of the amplification unit 150 becomes 0.0, and the gain of the amplification unit 151 becomes 1.0; and thus the addition unit 152 outputs the expansion frequency signals 107 as they are as the adjustment frequency signal 109. As a result, the multi-channel signals 105 outputted by the frequency synthesis unit 104 become the same as that of the conventional MPEG Surround.

When the user is not satisfied with the sound quality and wishes to improve it, the user inputs, to the information input unit 131, information that the sound quality is to be improved. In this case, based on the information inputted by the user that the sound quality is to be changed, the information input unit 131 outputs the sound quality adjustment information 141 including information which indicates that the gain αi (where i=0 to 5) is the value other than 0.0 (0.5, for example).

Due to this, the gain of the amplification unit 150 becomes 0.5, and the gain of the amplification unit 151 becomes 0.5; and the addition unit 152 outputs the adjustment frequency signal 109, in which the monaural signal that the sound quality is ensured with respect to the expansion frequency signal 107, is added. As a result, the multi-channel signals 105 outputted by the frequency synthesis unit 104 become such that the realistic sound experience of the conventional MPEG Surround is suppressed, but the sound quality is improved instead.

As described above, the multi-channel decoding device 20 according to the first embodiment of the present invention adds, to the expansion frequency signals 107, the high quality monaural frequency signal 108 on which the separation processing has not been performed, when the user feels uncomfortable with the sound quality of the multi-channel signals, thereby improving the sound quality although the realistic sound experience is being suppressed. With this, the multi-channel decoding device 20 can alleviate uncomfortable feeling caused due to sound degradation of the multi-channel signals.

The multi-channel decoding device 20 according to the first embodiment of the present invention has been described above; however, it should be noted that the present invention is limited to this embodiment.

For example, the example where the monaural signal 100 is inputted has been described above; however, multi-channel signals such as stereo signals may be inputted.

Hereinafter, an example where the stereo signals are inputted will be described.

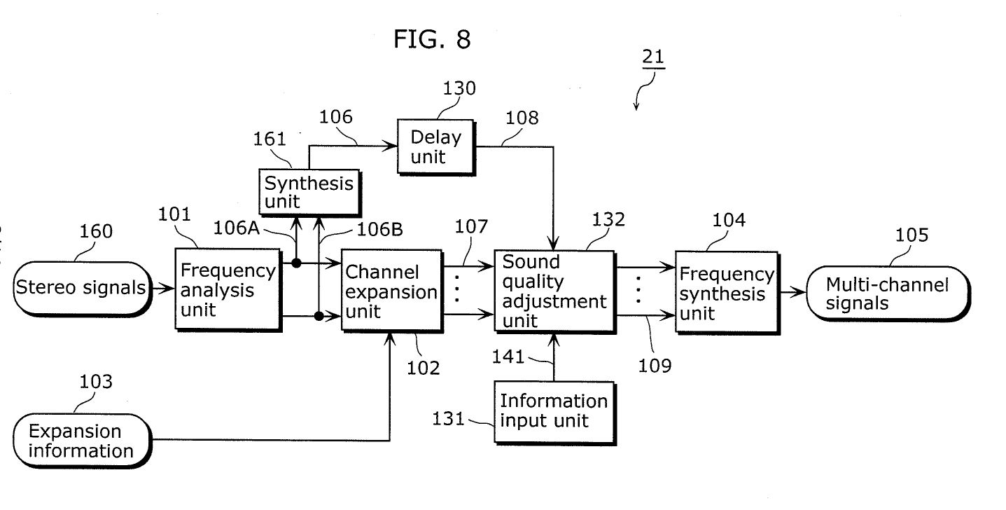

FIG. 8 is a diagram showing a structure of a variation of the multi-channel decoding device 20.

A multi-channel decoding device 21 shown in FIG. 8 includes a synthesis unit 161 in addition to the structure of the multi-channel decoding device 20.

The frequency analysis unit 101 converts 2-channel stereo signals 160 into 2-channel stereo frequency signals 106A and 106B.

The synthesis unit 161 generates the monaural frequency signal 106 by synthesizing the stereo frequency signals 106A and 106B.

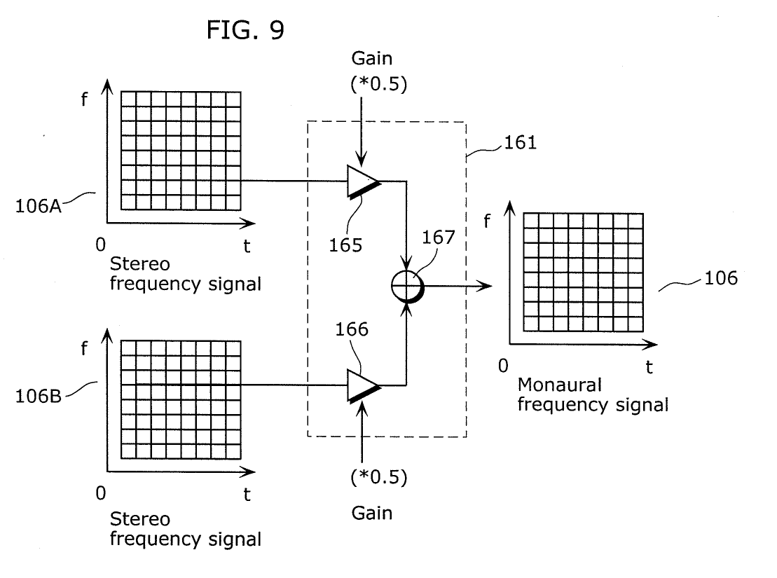

FIG. 9 is a diagram showing the structure of the synthesis unit 161.

The synthesis unit 161 includes amplification units 165 and 166, and an addition unit 167. The amplification units 165 and 166 amplify the stereo frequency signals 106A and 106B by gain 0.5, respectively. The addition unit 167 generates the monaural frequency signal 106 by adding the signals amplified by the amplification units 165 and 166.

The sound quality adjustment unit 132 adjusts the sound quality of the expansion frequency signals 107 using the monaural frequency signal 106, similar to the multi-channel decoding device 20.

Furthermore, also in the case where multi-channel signals of 3 or more channels are inputted, the monaural signal may be generated by adding the multi-channel signals.

Further, in the description above, the example has been shown where the uniform gain αi is used for the six expansion frequency signals 107 in the sound quality adjustment unit 132; however, it may be that the sound quality adjustment information 141 includes information which designates the respective six gains αi (where i=0 to 5), and different gains αi (where i=0 to 5) is used for the respective six expansion frequency signals 107i.

In addition, the gain αi may change dynamically according to at least one of frequency band and time. In other words, at least one of a certain frequency band and a certain time of the monaural frequency signal 106 may be weighted and added to the expansion frequency signals 107.

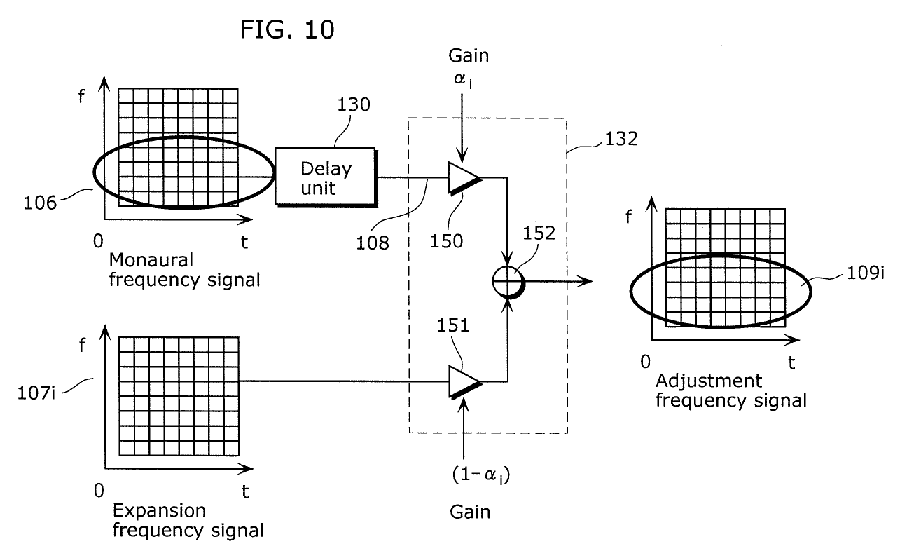

FIG. 10 is a diagram showing an example where the gain αi changes dynamically according to frequency band. In the example shown in FIG. 10, the low frequency band of the monaural frequency signal 106 is weighted. This improves the sound quality of the low frequency band that is easily perceived by humans, which allows maintaining the realistic sound experience of the multi-channel signals.

Further, the information input unit 131 may accept, according to the user's operation, several modes each designating that the sound quality is not to be changed or the sound quality is to be changed. For example, since the sound quality is not adjusted in the case where the gain αi is 0.0, the mode may be provided which indicates that “sound quality adjustment is to be turned off”. Since the sound quality is adjusted in the case where the gain αi is 0.5, the mode may be provided which indicates that “sound quality adjustment is to be turned on”. As described above, by preparing modes in advance which correspond to processing of the sound quality adjustment unit 132, the user can easily control sound quality adjustment.

Furthermore, the information input unit 131 may accept several modes other than the two options which are sound quality is not to be changed and sound quality is to be changed. For example, it may be that the mode where the sound quality is adjusted is subdivided and such modes are provided that the gain αi is 0.3 and that the gain αi is 0.7.

Furthermore, the information input unit 131 may include an interface in which the user can arbitrarily adjust the strength of sound quality adjustment within an effective parameter range. For example, the information input unit 131 may include a sound quality adjusting knob which is similar to the volume knob for volume adjustment and which can designate the gain αi by the user successively changing the gain αi. This allows the user to arbitrarily adjust the sound quality.

Furthermore, the information input unit 131 may include independent adjusting knobs for each channel. This allows the user to adjust the subtler sound quality.

Furthermore, in the above description, the multi-channel decoding device 20 includes only the delay unit 130 which delays the monaural frequency signal 106; however, the multi-channel decoding device 20 may further include a delay unit which delays the expansion frequency signals 107. In this case, the two delay units 130 delay the monaural frequency signal 106 and the expansion frequency signals 107 so that the time difference between the six expansion frequency signals 107 and the monaural frequency signal 106 can be eliminated.

### Second Embodiment

In the first embodiment described above, the example has been described where a monaural frequency signal 106 is added to expansion frequency signals 107. In the second embodiment, an example where a monaural signal 100 that is a time signal is added to the time signal on which the channel expansion has been performed.

In general, inside of the decoder cannot be modified in many cases. This may cause a case where it is difficult to directly change the QMF coefficient that is a parameter of the inside of the decoder, similar to a multi-channel decoding device 20 according to the first embodiment. A multi-channel decoding device according to the second embodiment adjusts the sound quality on a time axis with respect to multi-channel signals 105 that are outputs of the multi-channel decoding device.

First, the structure of the multi-channel decoding device according to the second embodiment will be described.

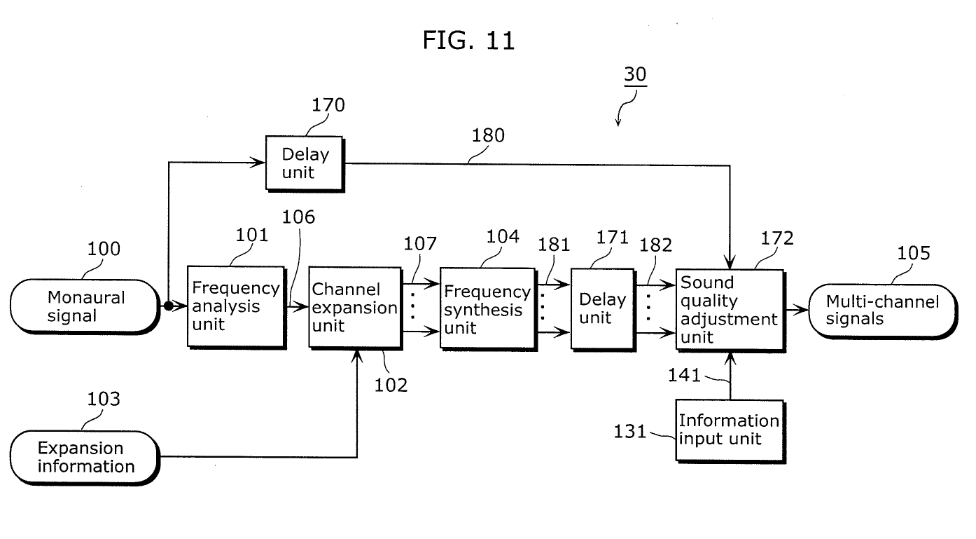

FIG. 11 is a block diagram showing the structure of the multi-channel decoding device according to the second embodiment. It should be noted that identical numerals are assigned to the elements similar to those of FIG. 5.

A multi-channel decoding device 30 shown in FIG. 11 converts a monaural frequency signal 106 that is a 1-channel input audio signal into the multi-channel signals 105 that are output audio signals of 5.1-channels by performing channel expansion processing on the monaural frequency signal 106 using expansion information 103.

The multi-channel decoding device 30 includes a frequency analysis unit 101, a channel expansion unit 102, delay units 170 and 171, an information input unit 131, a sound quality adjustment unit 172 and a frequency synthesis unit 104.

The structures of the frequency analysis unit 101, the channel expansion unit 102 and the information input unit 131 are the same as in the first embodiment, and thus the descriptions of them are omitted.

The frequency synthesis unit 104 generates 6-channel expansion time signals 181 by converting the respective 6-channel expansion frequency signals 107 from frequency signals to time signals.

The delay unit 170 generates a monaural time signal 180 by delaying the monaural signal 100 that is a time signal. The delay unit 171 generates 6-channel expansion time signals 182 by delaying the respective 6-channel expansion time signals 181. The difference of the delay given by the delay units 170 and 171 to the monaural signal 100 and the expansion time signals 181 is equivalent to the time period for processing in the frequency analysis unit 101, the channel expansion unit 102 and the frequency synthesis unit 104. In other words, the delay units 170 and 171 delay the monaural signal 100 and the expansion time signals 181 so that the time difference between the six expansion time signals 181 and the monaural signal 100 can be eliminated.

The sound quality adjustment unit 172 adjusts, based on sound quality adjustment information 141, the sound quality using the monaural time signal 180 with respect to 6-channel expansion time signals 182. More particularly, the sound quality adjustment unit 172 generates the multi-channel signals 105 of 6-channels by adding the respective 6-channel expansion time signals 182 and the monaural time signal 180 at a predetermined ratio.

The operations of the multi-channel decoding device 30 configured as above will be described.

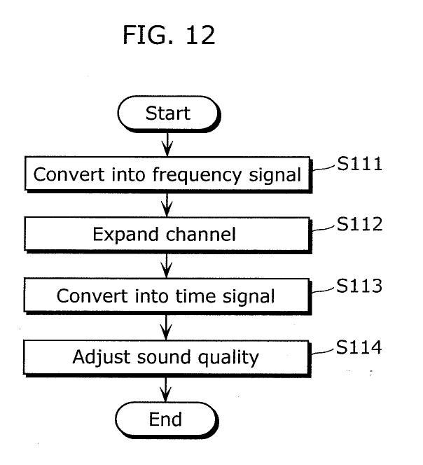

FIG. 12 is a flowchart of the flow of the operations of the multi-channel decoding device 30.

First, the frequency analysis unit 101 converts the monaural signal 100 into the monaural frequency signal 106 (S111).

Next, the channel expansion unit 102 generates the 6-channel expansion frequency signals 107 by expanding the channel of the monaural frequency signal 106 (S112).

Then, the frequency synthesis unit 104 generates the 6-channel expansion time signals 181 by converting the respective 6-channel expansion frequency signals 107 into time signals (S113). Furthermore, the delay unit 171 generates the 6-channel expansion time signals 182 by delaying the 6-channel expansion time signals 181

Then, the sound quality adjustment unit 172 adjusts, based on the sound quality adjustment information 141, the sound quality of the six expansion time signals 182 (S114).

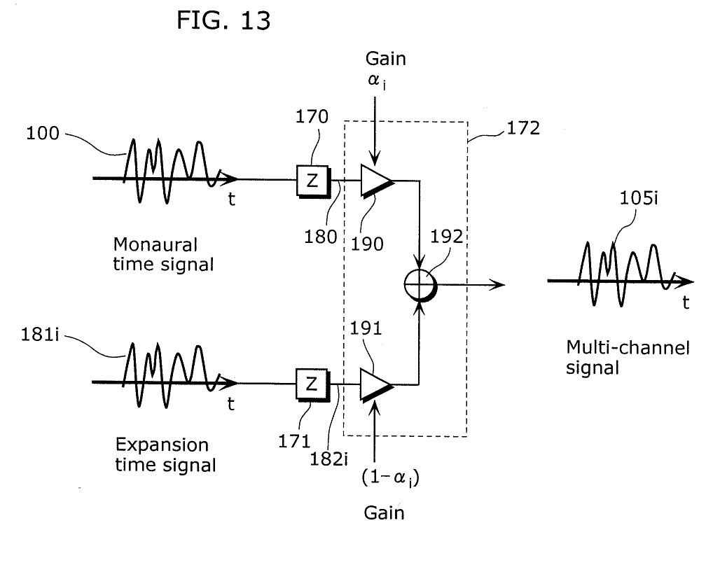

FIG. 13 is a diagram showing the structure of the sound quality adjustment unit 172.

Here, an example will be described where the sound quality adjustment is performed on an expansion time signal 181i that is one of the six expansion time signals 181 to generate a multi-channel signal 105i. The expansion time signal 181i is an expansion time signal of the i-th channel among the six expansion time signals 181. Furthermore, the multi-channel signal 105i is an i-th channel signal among the six multi-channel signals 105. Here, since the channel count of the multi-channel signals is assumed as 6, is assumed to take the value between 0 and 5. For example, when is 0, the expansion time signal 181i is a time signal of the left channel generated in the expansion processing.

The sound quality adjustment unit 172 includes amplification units 190 and 191, and an addition unit 192.

FIG. 13 shows the structure for adjusting the sound quality of the single expansion time signal 181i; however, the sound quality adjustment unit 172 actually includes 6 sets of amplification units 190 and 191 and addition unit 192 for adjusting the sound quality of the respective six expansion time signals 181.

The sound quality adjustment information 141 outputted by the information input unit 131 includes information of gain αi (where i=0 to 5) corresponding to the respective six expansion time signals 181.

The amplification unit 190 amplifies the monaural time signal 180 by gain αi. The amplification unit 191 amplifies the expansion time signal 182i by gain (1-αi). The expansion time signal 182i is an expansion time signal of the i-th channel among the six expansion time signals 182. The addition unit 192 generates the multi-channel signal 105i by adding the signals amplified by the amplification units 190 and 191.

Hereinafter, an example of the user's operation to the multi-channel decoding device 30 will be described.

The information input unit 131 includes an input unit for feedback from the user's sound quality evaluation. For example, when the user wishes to maintain the current sound quality, the user inputs, to the information input unit 131, information that the sound quality is not to be changed. Based on the information inputted by the user that the sound quality is not to be changed, the information input unit 131 outputs the sound quality adjustment information 141 including information which indicates that the gain αi (where i=0 to 5) is 0.0.

Due to this, the gain of the amplification unit 190 becomes 0.0, and the gain of the amplification unit 191 becomes 1.0; and thus the addition unit 192 outputs the expansion time signals 182 as they are, as the multi-channel signals 105. As a result, the multi-channel signals 105 become the same as that of the conventional MPEG Surround.

When the user is not satisfied with the sound quality and wishes to improve it, the user inputs, to the information input unit 131, information that the sound quality is to be improved. In this case, based on the information inputted by the user that the sound quality is to be changed, the information input unit 131 outputs the sound quality adjustment information 141 including information which indicates that the gain αi (where i=0 to 5) is the value other than 0.0 (0.5, for example).

Due to this, the gain of the amplification unit 190 becomes 0.5, and the gain of the amplification unit 191 becomes 0.5; and the addition unit 192 outputs the multi-channel signals 105, in which the monaural signal 100 that the sound quality is ensured with respect to the expansion time signals 182, is added. As a result, the multi-channel signals 105 become such that the realistic sound experience of the conventional MPEG Surround is suppressed, but the sound quality is improved instead.

As described above, the multi-channel decoding device 30 according to the second embodiment of the present invention adds, to the expansion time signals 182, the high quality monaural frequency signal 180 on which the separation processing has not been performed, when the user feels uncomfortable with the sound quality of the multi-channel signals 105, thereby improving the sound quality although the realistic sound experience is being suppressed. With this, the multi-channel decoding device 30 can alleviate uncomfortable feeling caused due to sound degradation of the multi-channel signals.

The multi-channel decoding device 30 according to the second embodiment of the present invention does not require the QMF coefficient that is a parameter of the inside of the decoder be directly changed, and thus there is an advantage that implementation of the multi-channel decoding device 30 is easier than the multi-channel decoding device 20 according to the first embodiment.

It should be noted that the multi-channel decoding device 20 according to the first embodiment has an advantage that the implementation of the multi-channel decoding device 20 can be performed in a simpler algorithm compared to the multi-channel decoding device 30 according to the second embodiment.

In the description above, the example has been shown where the uniform gain αi is used for the six expansion time signals 182 in the sound quality adjustment unit 172; however, the sound quality adjustment information 141 may include information which designates the respective six gains αi (where i=0 to 5), and different gains αi (where i=0 to 5) may be used for the respective six expansion time signals 182i.

Furthermore, the gain αi may change dynamically according to at least one of frequency band and time. In other words, at least one of a certain frequency band and a certain time of the monaural signal 100 may be weighted and added to the expansion time signals 181.

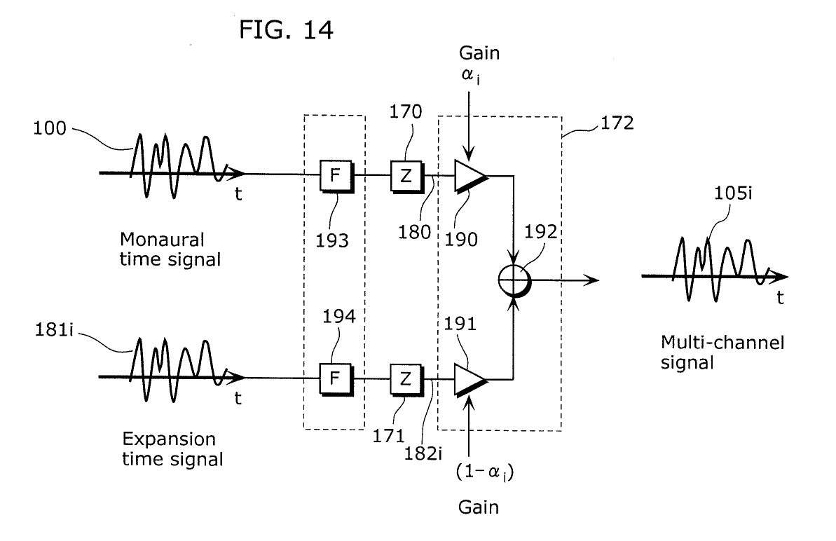

FIG. 14 is a diagram showing an example where the gain αi dynamically changes according to the frequency band. In the example shown in FIG. 14, the multi-channel decoding device 30 further includes equalizers 193 and 194.

Furthermore, the information input unit 131 includes an interface where the user can perform equalization.

The equalizers 193 and 194 perform, according to the user's desire, equalization to change the signal in a certain frequency band of the monaural signal 100 and the expansion time signals 181. By equalizing the monaural signal 100 and the expansion time signals 181 as described, the multi-channel decoding device 30 can flexibly adjust the sound quality according to each user's perception of the sound quality degradation.

It has been described above that the multi-channel decoding device 30 includes the delay units 170 and 171; however, only the delay unit 170 may be included.

Furthermore, the multi-channel decoding device 30 may receive multi-channel signals such as stereo signals, as in the first embodiment.

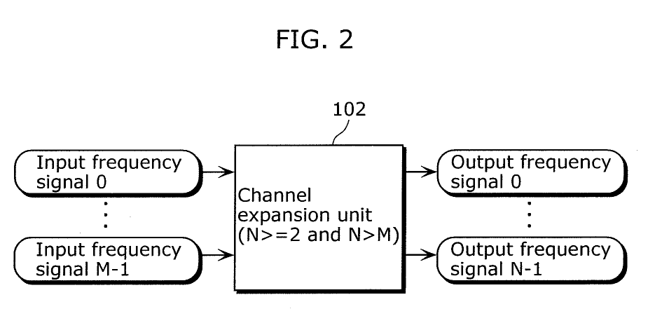

Furthermore, in the above first and second embodiments, the case where the monaural signal or stereo signals is expanded to the multi-channel signals of 5.1-channels has been described; however, the present invention can be applied to a multi-channel decoding device in which a M-channel signal (where M is an integer number of 1 or more) is expanded to N-channel signals (where N>M) as shown in FIG. 2.

Moreover, in the above first and second embodiments, it has been described that the multi-channel decoding devices 20 and 30 adjust the sound quality according to the user's operation via the information input unit 131. However, it may be that the multi-channel decoding devices 20 and 30 analyze the multi-channel signals 105 outputted by themselves, and automatically adjust the sound quality when the multi-channel signals 105 includes noise or the like and possibly gives the user uncomfortable feeling. Further, it may be that an external device analyzes the necessity of the sound quality adjustment, and the multi-channel decoding devices 20 and 30 adjust the sound quality based on the instruction from the external device.

Further, in the above first and second embodiments, it has been described that the channel expansion unit 102 performs channel expansion using the expansion information 103; however, the expansion information 103 may not necessarily be used.

Furthermore, in the above first and second embodiments, it has been described that the channel expansion unit 102 reproduces the monaural signal or stereo signals to all of the original 6-channel signals; however, all signals may not be necessarily be reproduced. For example, when the audio device for vehicle includes only four speakers 11, the center channel signal and the subwoofer signal among the 6-channel signals do not need to be reproduced.

Further, in the above first and second embodiments, the example of the audio device for vehicle which playbacks broadcast audio stream is described; however, the present invention can be applied to an audio playback device which playbacks broadcast audio stream such as home theater. The present invention can also be applied to an audio playback device which playbacks audio recorded in a recoding media and the like. The present invention is especially effective in an audio playback device which playbacks broadcast audio stream in which the bit rate cannot be increased when the user feels uncomfortable with the sound quality.

### INDUSTRIAL APPLICABILITY

The present invention can be applied to a multi-channel decoding device, particularly to an audio device for vehicle and a home theater.

1. A multi-channel decoding device which converts an input audio signal of an input channel count that is at least one into output audio signals of an output channel count that is greater than the input channel count, said multi-channel decoding device comprising:
a first expansion unit configured to generate expansion signals of the output channel count by expanding a channel count of the input audio signal of the input channel count; and
a first addition unit configured to generate one of the output audio signals of the output channel count by adding, at a predetermined ratio, one of the expansion signals of the output channel count and the input audio signal.

2. The multi-channel decoding device according to claim 1, further comprising:
a first conversion unit configured to generate the input audio signal of the input channel count by converting an input time signal of the input channel count from a time signal to a frequency signal; and
a second conversion unit configured to generate output time signals of the output channel count by converting each of the output audio signals of the output channel count from a frequency signal to a time signal,
wherein said first expansion unit is configured to generate the expansion signals of the output channel count by expanding the channel count of the input audio signal of the input channel count, each of the expansion signals being a frequency signal, the input audio signal being a frequency signal converted by said first conversion unit, and
said first addition unit is configured to generate the output audio signals of the output channel count by adding, at the predetermined ratio, one of the expansion signals of the output channel count and the input audio signal, each of the output audio signals, the expansion signals and the input audio signal being a frequency signal.

3. The multi-channel decoding device according to claim 1,
wherein said first expansion unit includes:
a first conversion unit configured to generate an input frequency signal of the input channel count by converting the input audio signal of the input channel count from a time signal to a frequency signal; and
a second expansion unit configured to generate the expansion signals of the output channel count by expanding a channel count of the input frequency signal of the input channel count, and
said first addition unit includes:
a second conversion unit configured to generate output time signals of the output channel count by converting each of the expansion signals of the output channel count from a frequency signal to a time signal; and
a second addition unit configured to generate the output audio signals of the output channel count by adding, at the predetermined ratio, one of the output time signals of the output channel count and the input audio signal, each of the output audio signals being a time signal.

4. The multi-channel decoding device according to claim 1,
wherein said first addition unit is configured to weight a certain frequency-time band of the input audio signal, and add, at the predetermined ratio, one of the expansion signals of the output channel count and the input audio signal.

5. The multi-channel decoding device according to claim 1, further comprising
an information input unit configured to generate gain information which designates the predetermined ratio according to an operation of a user,
wherein said first addition unit is configured to add one of the expansion signals of the output channel count and the input audio signal at the predetermined ratio designated by the gain information.

6. The multi-channel decoding device according to claim 5,
wherein said information input unit is configured to accept a plurality of modes each designating the predetermined ratio according to the operation of the user.

7. The multi-channel decoding device according to claim 5,
wherein said information input unit is configured to generate the gain information which designates the predetermined ratio for each of the output audio signals of the output channel count according to the operation of the user, and
said first addition unit is configured to add each of the expansion signals of the output channel count and the input audio signal at the corresponding predetermined ratio designated by the gain information.

8. The multi-channel decoding device according to claim 5,
wherein said information input unit includes an adjusting knob for designating the predetermined ratio by the user successively changing the predetermined ratio.

9. The multi-channel decoding device according to claim 1,
wherein the input audio signal of the input channel count is generated by synthesizing audio signals of the output channel count, and
said first expansion unit is configured to generate the expansion signals of the output channel count by expanding the channel count of the input audio signal of the input channel count, using expansion information which is generated in the synthesizing and indicates an inter-channel relationship of the audio signals.

10. The multi-channel decoding device according to claim 1,
wherein the input channel count is two or more, and
said first addition unit is configured to average the two or more input audio signals, and add, at the predetermined ratio, one of the expansion signals of the output channel count and the averaged input audio signal.

11. A multi-channel decoding method for converting an input audio signal of an input channel count that is at least one into output audio signals of an output channel count that is greater than the input channel count, said method comprising:
generating expansion signals of the output channel count by expanding a channel count of the input audio signal of the input channel count; and
generating one of the output audio signals of the output channel count by adding, at a predetermined ratio, one of the expansion signals of the output channel count and the input audio signal.

12. A program causing a computer to execute a multi-channel decoding method for converting an input audio signal of an input channel count that is at least one into output audio signals of an output channel count that is greater than the input channel count, the method comprising:
generating expansion signals of the output channel count by expanding a channel count of the input audio signal of the input channel count; and
generating one of the output audio signals of the output channel count by adding, at a predetermined ratio, one of the expansion signals of the output channel count and the input audio signal.

13. A semiconductor integrated circuit which converts an input audio signal of an input channel count that is at least one into output audio signals of an output channel count that is greater than the input channel count, said semiconductor integrated circuit comprising:
a first expansion unit configured to generate expansion signals of the output channel count by expanding a channel count of the input audio signal of the input channel count; and
a first addition unit configured to generate one of the output audio signals of the output channel count by adding, at a predetermined ratio, one of the expansion signals of the output channel count and the input audio signal.
